(19) United States
(12) Patent Application Publication
(10) Pub. No.: US 2025/0344160 A1
(43) Pub. Date: Nov. 6, 2025

(54) POWER TRANSMISSION MANAGEMENT AND INTERFERENCE MITIGATION ON A WIRELESS GATEWAY DEVICE

(71) Applicant: Charter Communications Operating, LLC, St. Louis, MO (US)

(72) Inventor: Balmis Orestes Lopez Soriano, McKinney, TX (US)

(21) Appl. No.: 18/655,696

(22) Filed: May 6, 2024

(51) Int. Cl. H04W 52/14; H04W 52/36

(52) U.S. Cl. CPC H04W 52/146; H04W 52/36

(57) ABSTRACT

A gateway device receives a first message from a server device, the first message comprising a first power level indicator corresponding to a first desired output radio frequency (RF) power level for the gateway device, the gateway device being inoperable to transmit at the first desired output RF power level. In response to the first message, the gateway device sets an output RF power level of the gateway device to an output RF power level that is different from the first desired output RF power level. The gateway device sends, to an RF attenuator that is communicatively coupled to an RF output of the gateway device, an instruction to attenuate the output RF power level of the gateway device such that an attenuated output RF power level matches the first desired output RF power level.

### BACKGROUND

Certain types of Internet of Things (IoT) devices, such as sensors, actuators, and the like, utilize low power, low bit rate, long range communications to convey and/or receive information.

### SUMMARY

The examples disclosed herein implement mechanisms to cause a gateway device and RF attenuator to output RF signals at power levels at which the gateway device was not designed to transmit.

In one implementation a method is provided. The method includes receiving, by a gateway device from a server device, a first message, the first message comprising a first power level indicator corresponding to a first desired output radio frequency (RF) power level for the gateway device, the gateway device being inoperable to transmit at the first desired output RF power level. The method further includes in response to the first message, setting, by the gateway device, an output RF power level of the gateway device to an output RF power level that is different from the first desired output RF power level. The method further includes sending, by the gateway device to an RF attenuator that is communicatively coupled to an RF output of the gateway device, an instruction to attenuate the output RF power level of the gateway device such that an attenuated output RF power level matches the first desired output RF power level.

In another implementation a gateway device is provided. The gateway device includes a memory, a processor device coupled to the memory. The processor device is operable to receive, from a server device, a first message, the first message comprising a first power level indicator corresponding to a first desired output radio frequency (RF) power level for the gateway device, the gateway device being inoperable to transmit at the first desired output RF power level. The processor device is further operable to, in response to the first message, set an output RF power level of the gateway device to an output RF power level that is different from the first desired output RF power level. The processor device is further operable to send, to an RF attenuator that is communicatively coupled to an RF output of the gateway device, an instruction to attenuate the output RF power level of the gateway device such that an attenuated output RF power level matches the first desired output RF power level.

In another implementation another method is provided. The method includes receiving, by a server device, an instruction to cause a first gateway device to transmit at a first desired output radio frequency (RF) power level. The method further includes accessing, by the server device, a first data structure that corresponds to the first gateway device, the first data structure correlating a first plurality of power level indicators to corresponding output RF power levels. The method further includes determining, by the server device based on the first data structure, that the first gateway device is inoperable to transmit at the first desired output RF power level. The method further includes sending, by the server device to the first gateway device based on the first data structure, a first power level indicator that corresponds to the first desired output RF power level. The method further includes sending, by the server device to an RF attenuator that is communicatively coupled to the first gateway device, an instruction to attenuate the output RF power level of the first gateway device to cause an attenuated output RF power level to match the first desired output RF power level.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment in which power transmission management and interference mitigation on a wireless gateway device can be practiced according to some implementations;

FIG. 2 is a flowchart of a method for power transmission management and interference mitigation on a wireless gateway device according to some implementations;

FIG. 3 is a flowchart of a method for power transmission management and interference mitigation on a wireless gateway device from the perspective of a server device according to some implementations;

FIGS. 4A-4C are sequence diagrams illustrating actions taken by and messages communicated between various components illustrated in FIG. 1 while implementing power transmission management and interference mitigation on a wireless gateway device according to one example;

FIG. 5 is a block diagram of a gateway device illustrated in FIG. 1 according to one implementation; and

FIG. 6 is a block diagram of a server device illustrated in FIG. 1 according to one implementation.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Certain types of Internet of Things (IoT) devices, such as sensors and the like, utilize low power, low bit rate, long range communications to convey and/or receive information. Such devices will be referred to herein as end devices. Examples of end devices include, by way of non-limiting example, sensors and actuators. Example use cases of such end devices include, for example, sensors that are used to ensure vaccines are kept at appropriate temperatures in transit, tracking sensors used to manage endangered species, wristband sensors to provide fall detection and medication tracking for dementia patients, moisture sensors that provide real time insights into crop soil moisture, and the like.

End devices may utilize a low-power long range protocol to communicate, such as, by way of non-limiting example, the LoRa and LoRaWan communication protocols recognized as Recommendation ITU-T Y.4480 “Low power protocol for wide area wireless networks”.

End devices may have certain characteristics, such as, by way of non-limiting example, long range communication of up to 10 miles in line of sight, long battery duration of up to 10 years, low power requirements and may have a limited payload size of 51 bytes to 241 bytes depending on the data rate. In some implementations the data rate may be 0.3 Kbit/s-27 Kbit/s data rate with a 222 maximal payload size.

End devices are typically configured to communicate with a gateway device using a low power long range (LPLR) wireless protocol, such as the LoRa and LoRaWan protocol described in Recommendation ITU-T Y.4480. The gateway device may in turn be communicatively coupled to a network server device. The gateway device serves as an intermediary for communications between the client devices and the network server, and implements the particular LPLR wireless protocol to communicate with the client devices. The gateway device may communicate with the server device via any conventional wired or wireless backhaul technologies, such as fiber, Ethernet, cellular, or the like.

A gateway device may be designed and manufactured to only transmit at certain power increments, such as 2 decibel milliwatts (dBm) increments. However, where multiple gateway devices are implemented in proximity to one another, it may be desirable to increment a power level in smaller dBm increments, such as 1 dBm increments, to minimize interference between such gateway devices.

An entity, such as a service provider, may implement gateway devices from different manufacturers. Each manufacturer may utilize different command/instruction syntaxes when communicating with the network server device. If the network server utilizes the wrong syntax or commands in an attempt to cause the gateway device to transmit at a certain power level and the gateway device does not understand the command, the gateway device may be designed, by default, to transmit at the maximum power level of the gateway device. Unfortunately, transmitting at the maximum power level may cause interference with other gateway devices.

The examples disclosed herein implement mechanisms to cause a gateway device to transmit RF signals at power levels at which the gateway device was not designed to transmit. The examples disclosed herein also implement standardized communication structures that reside on both the network server device and the gateway device to ensure that the network server device and the gateway device implement predetermined commands to ensure the gateway device transmits at the desired output RF level.

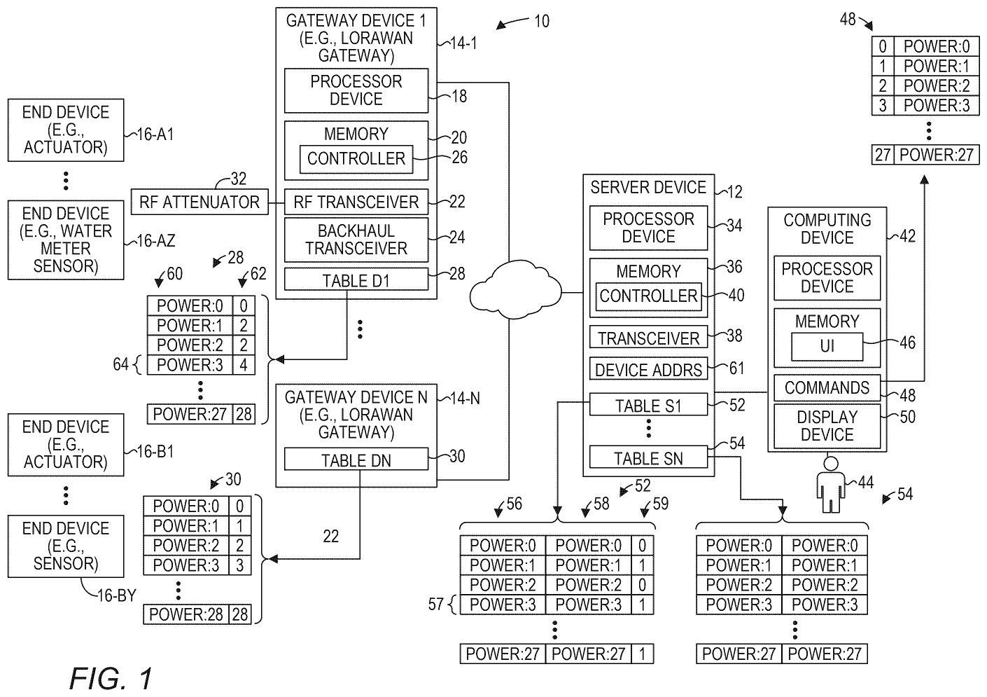

FIG. 1 is a block diagram of an environment 10 in which power transmission management and interference mitigation on a wireless gateway device can be practiced according to some implementations. The environment 10 includes a server device 12 that communicates with a plurality of gateway devices 14-1-14-N (generally, gateway devices 14). The gateway devices 14 communicate with end devices. In this example, the gateway device 14-1 communicates with a plurality of end devices 16-A1-16-AZ and the gateway device 14-2 communicates with a plurality of end devices 16-B1-16-BY. The end devices 16-A1-16-AZ and 16-B1-16-BY may be referred to generally as end devices 16. The end devices 16 comprise low power devices that may utilize a battery for power. The end devices 16 may comprise, for example, sensors, actuators, or the like. The end devices 16 utilize a low-power long range radio frequency protocol to communicate with the respective gateway devices 14, such as, by way of non-limiting example, the LoRa and LoRaWan communication protocols recognized as Recommendation ITU-T Y.4480 “Low power protocol for wide area wireless networks”, although the examples disclosed herein are not limited to any particular low-power long range protocol.

The end device 16 may have certain characteristics, such as, by way of non-limiting example, long range communication capabilities of up to 10 miles in line of sight, long battery duration of up to 10 years, and low power requirements. The end devices 16 may utilize a communications protocol that uses a limited payload size, such as, by way of non-limiting example, 51 bytes to 241 bytes, depending on the data rate. In some implementations the data rate may be relatively low speed, such as 0.3 Kbit/s-27 Kbit/s data rate.

The gateway device 14-1 includes a processor device 18 and a memory 20. The gateway device 14-1 uses an RF transceiver 22 to communicate with the end devices 16-A1-16-AZ. As discussed above, the RF transceiver 22 may utilize a low power communication protocol, such as, by way of non-limiting example, Recommendation ITU-T Y.4480 “Low power protocol for wide area wireless networks”. The RF transceiver 22 may utilize a certain frequency band, such as 902-928 MHz to communicate with the end devices 16-A1-16-AZ. The gateway device 14-1 includes a backhaul transceiver 24 for communication with the server device 12 via any suitable communications technology, such as Ethernet, cellular, fiber, or the like. The gateway device 14-1 includes a controller 26 for implementing certain functionality, as will be described herein. The gateway device 14-1 includes a data structure 28 for translating commands (e.g., instructions) received from the server device 12. The gateway device 14-N is configured substantially similarly to the gateway device 14-1, and includes a data structure 30 for translating commands (e.g., instructions) received from the server device 12.

The gateway device 14-1 is capable of transmitting at predetermined RF power levels that are 2 dBm apart up to a maximum power level of, for example, 28 dBm. Thus, the gateway device 14-1 can transmit, for example, at

RF power output levels of 2, 4, 6 and 8 dBm, but cannot transmit at RF power output levels of 1, 3, 5 and 7 dBm. The gateway device 14-N is capable of transmitting at RF power levels that are 1 dBm apart up to a maximum power level of, for example, 28 dBm.

An RF attenuator 32 is communicatively coupled to an RF output of the RF transceiver 22 and is operable, upon request, to attenuate the RF output of the RF transceiver 22 by 1 dBm, or to not attenuate the RF output of the RF transceiver 22. In some implementations, the RF attenuator 32 also utilizes the same communication protocol to communicate with the gateway device 14-1 as the end devices 16. The gateway device 14-N is capable of transmitting at RF power levels that are 1 dBm apart up to a maximum power level of, for example, 28 dBm, and thus does not need an RF attenuator to output RF at a desired power level.

The server device 12 includes a processor device 34, a memory 36, and one or more transceivers 38 operable to communicate with other devices, such as, for example, the gateway devices 14. The server device 12 may have no capability to directly communicate with the end devices 16, but may communicate with the end devices 16 via the gateway devices 14. The server device 12 may also communicate with the RF attenuator 32 via the gateway device 14-1. The server device 12 includes a controller 40, which implements certain functionality as described below. The environment 10 may also include a computing device 42 utilized by an operator 44 to communicate with the server device 12 in order to set a desired output RF power level for one or more of the gateway devices 14.

With this background, an example of power transmission management and interference mitigation on a wireless gateway device will be discussed. Assume that the operator 44 desires to set an output RF power level for the gateway device 14-1. The operator 44 interacts with a user interface (UI) 46. The UI 46 may present a plurality of commands 48 on a display device 50 that identify, for each output RF power level, a corresponding command/instruction. For example, the commands 48 indicate that to set the gateway device 14-1 to an output RF power level of 2 dBm, the operator 44 should enter “POWER:2”. The commands 48 may be identical for all gateway devices 14. To set the gateway device 14-1 to an output RF power level of 3 dBm, the operator 44 should enter “POWER:3”. In this example, the operator 44 enters an identifier of the gateway device 14-1, and the instruction “POWER:3” to cause the server device 12 to set the output RF power level of the gateway device 14-1 to 3 dBm.

The controller 40 of the server device 12 receives the instruction. The controller 40 contains, or has access to, a data structure 52 that corresponds to the gateway device 14-1 and a data structure 54 that corresponds to the gateway device 14-N. The controller 40 accesses the data structure 52. A column 56 identifies commands that the controller 40 may receive from the UI 46 and a column 58 that identifies, for each such command, the command that the controller 40 should send to the gateway device 14-1 to implement the desired output RF power level. In this example, an entry 57 indicates that the command to be sent to the gateway device 14-1 is “POWER:3”. While in this example, the commands that the controller 40 may receive from the UI 46 and the command that the controller 40 should send to the gateway device 14-1 to implement the desired output RF power level are identical, in other implementations, they may differ.

The existence of a column 59 is an indicator that the gateway device 14-1 uses an RF attenuator to attenuate the output RF power level of the gateway device 14-1 for certain output RF power levels that the gateway device 14-1 cannot output. The column 59 indicates, for each row/entry of the data structure 52, whether the RF attenuator 32 is to be instructed by the controller 40 to attenuate the output RF power level by 1 dBm or to not attenuate the output RF power level. A value of 1 indicates that the gateway device 14-1 is inoperable to transmit at the desired output RF power level (i.e., 3 dBm) and the controller 40 is to instruct the RF attenuator 32 to attenuate the output RF power level by 1 dBm. The data structure 54 contains similar columns as columns 56 and 58 of the data structure 52, but lacks a third column, such as the column 59 of the data structure 52. The lack of such a column indicates that the gateway device 14-N does not need an RF attenuator to output a desired RF power level. Other data may be used in other implementations to identify which gateway devices 14 utilize RF attenuators.

The controller 40 accesses a device address data structure 61 that contains the addresses of the gateway devices 14, the end devices 16, and the RF attenuator 32. The controller 40 generates a message addressed to the gateway device 14-1 that includes a power level indicator corresponding to a desired output RF radio power level. In this example, the power level indicator is “POWER:3” and corresponds to a desired output RF radio power level of 3 dBm. The controller 40 also generates an instruction addressed to the RF attenuator 32 to attenuate the output RF power level of the gateway device 14-1. The instruction may identify that the output RF power level is to be attenuated by 1 dBm, or the RF attenuator 32 may by default attenuate the output RF power level by 1 dBm upon receipt of the instruction to attenuate the output RF power level. The controller 40 sends the instruction to the gateway device 14-1 for delivery to the RF attenuator 32.

The controller 26 of the gateway device 12-1 receives from the controller 40 the message that includes the power level indicator corresponding to a desired output RF radio power level. The controller 40 extracts the power level indicator from the message. The gateway device 12-1 is inoperable to transmit at the first desired output RF power level of 3. The controller 26 accesses a data structure 28 that correlates a plurality of power level indicators to corresponding output RF power levels of the gateway device 12-1. In particular, the data structure 28 contains a column 60 that identifies potential power level indicators that may be received from the server device 12, and a column 62 that contains corresponding output RF power levels to which the gateway device 14-1 should be set. In this example, an entry 64 corresponding to the power level indicator “POWER: 3” indicates that the controller 26 should set the output RF power level of the gateway device 14-1 to 4 dBm. In response to the message and based on the entry 64 of the data structure 28, the controller 26 sets the output RF power level of the gateway device 14-1 to an output RF power level of 4 dBm, which is different from the desired output RF power level of 3 dBm.

The controller 26 receives from the controller 40 the instruction that is addressed to the RF attenuator 32. The controller 26 sends the instruction to attenuate the output RF power level of the gateway device 12-1 to the RF attenuator 32. When the 4 dBm output RF power level of the gateway device 12-1 is attenuated by the RF attenuator 32 by 1 dBm, the attenuated output RF power level matches the desired output RF power level of 3 dBm. In some implementations, the controller 26 communicates with the RF attenuator 32 via the same low-power long range radio frequency protocol to communicate with the end devices 16. In some implementations, the gateway device 12-1 may utilize a frequency in a range between 902 MHz and 928 MHz.

It is noted that, in this example, the server device 12 originates the message to the RF attenuator 32. In other implementations, the data structure 28 may include information that indicates whether the RF attenuator 32 should attenuate the output RF power level of the gateway device 14-1. For example, the entry 64 may include an additional field that indicates that the controller 26 is to send an instruction to the RF attenuator 32 to attenuate the output RF power level of the gateway device 14-1 by 1 dBm. In such implementations, the gateway device 12-1 does not receive an instruction from the server device 12-1 and instead generates and sends the instruction to the RF attenuator 32 to attenuate the output RF power level of the gateway device 14-1 by 1 dBm.

It is noted that, because the controller 26 is a component of the gateway device 14-1, functionality implemented by the controller 26 may be attributed to the gateway device 14-1 generally. Moreover, in examples where the controller 26 comprises software instructions that program the processor device 18 to carry out functionality discussed herein, functionality implemented by the controller 26 may be attributed herein to the processor device 18. It is similarly noted that, because the controller 40 is a component of

the server device 12, functionality implemented by the controller 40 may be attributed to the server device 12 generally. Moreover, in examples where the controller 40 comprises software instructions that program the processor device 34 to carry out functionality discussed herein, functionality implemented by the controller 40 may be attributed herein to the processor device 34.

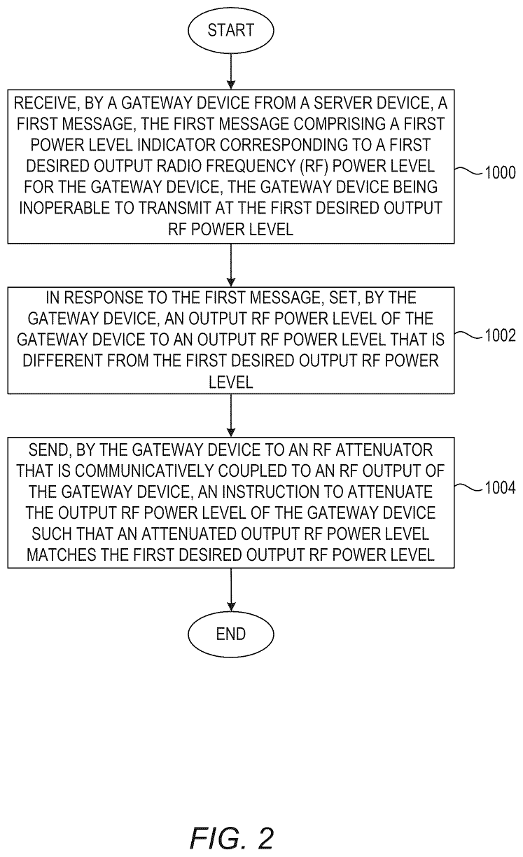

FIG. 2 is a flowchart of a method for power transmission management and interference mitigation on a wireless gateway device according to some implementations. FIG. 2 will be discussed in conjunction with FIG. 1. The gateway device 14-1 receives, from the server device 12, a message, the message comprising the power level indicator corresponding to the desired output RF power level for the gateway device 14-1, the gateway device 14-1 being inoperable to transmit at the desired output RF power level (FIG. 2, block 1000). The gateway device 14-1, in response to the message, sets the output RF power level of the gateway device 14-1 to an output RF power level that is different from the desired output RF power level (FIG. 2, block 1002). The gateway device 14-1 sends, to the RF attenuator 32 that is communicatively coupled to an RF output of the gateway device 14-1, an instruction to attenuate the output RF power level of the gateway device 14-1 such that an attenuated output RF power level matches the first desired output RF power level (FIG. 2, block 1004).

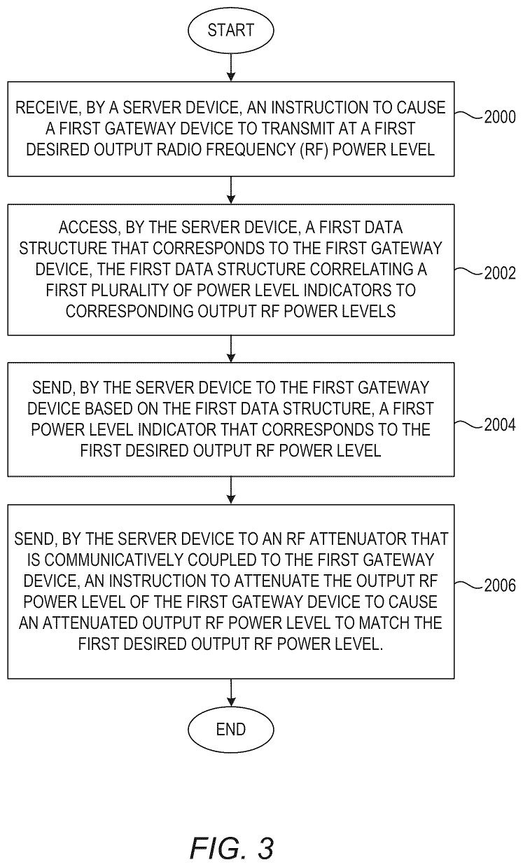

FIG. 3 is a flowchart of a method for power transmission management and interference mitigation on a wireless gateway device from the perspective of the server device 12 according to some implementations. FIG. 3 will be discussed in conjunction with FIG. 1. The server device 12 receives an instruction to cause the gateway device 14-1 to transmit at a desired output RF power level (FIG. 3, block 2000). The server device 12 accesses the data structure 52 that corresponds to the gateway device 14-1, the data structure 52 correlating a plurality of power level indicators to corresponding output RF power levels (FIG. 3, block 2002). The server device 12 sends, to the gateway device 14-1 based on the data structure 52, a power level indicator that corresponds to the desired output RF power level (FIG. 3, block 2004). The server device 12 sends, to the RF attenuator 32 that is communicatively coupled to the gateway device 14-1, an instruction to attenuate the output RF power level of the gateway device 14-1 to cause an attenuated output RF power level to match the desired output RF power level (FIG. 3, block 2006).

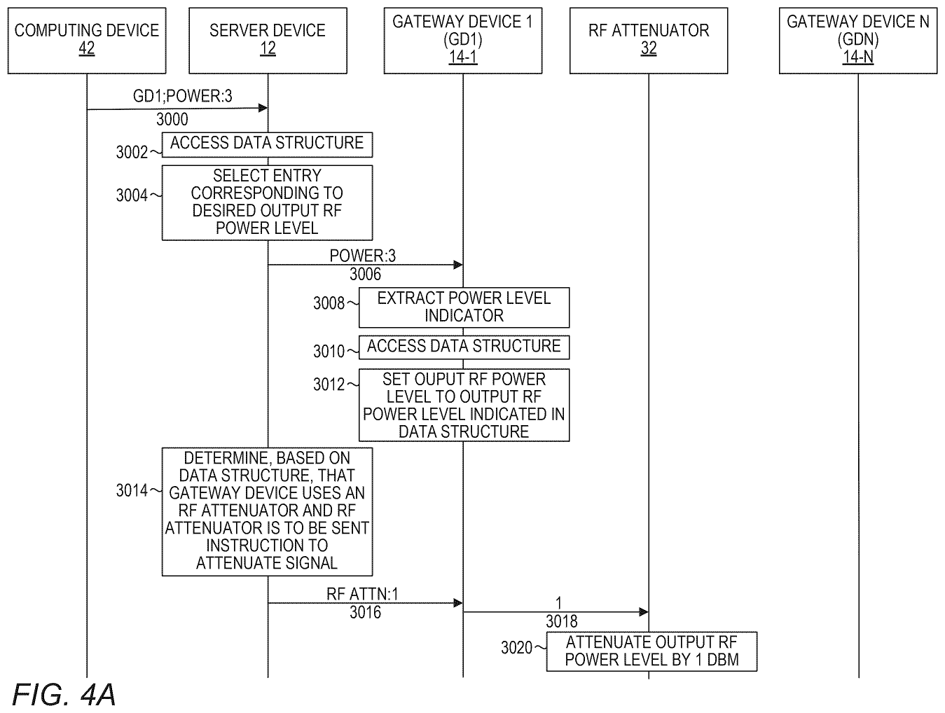

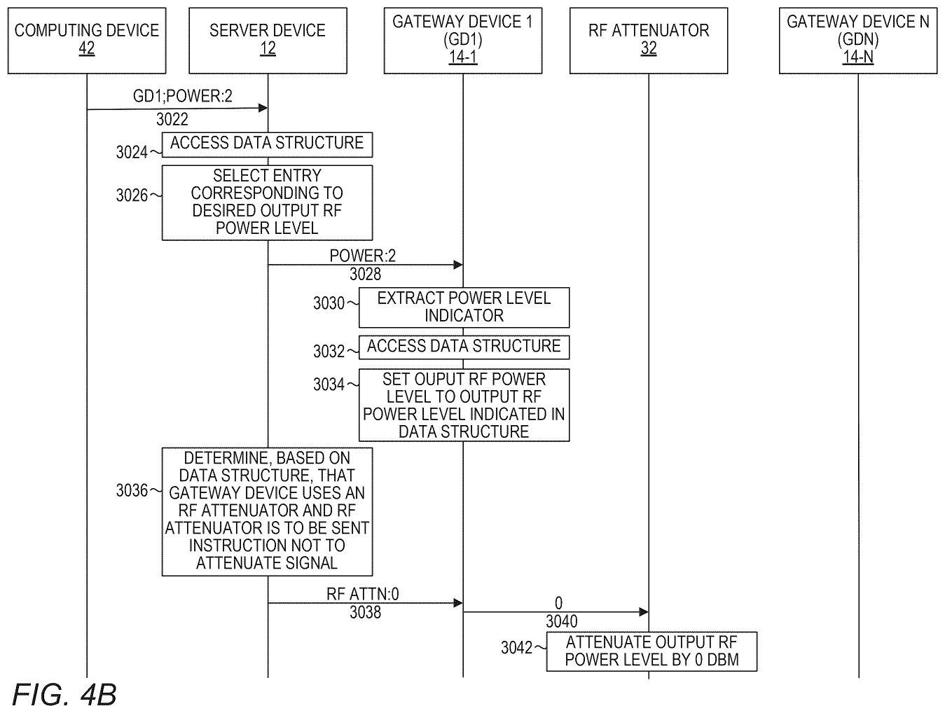

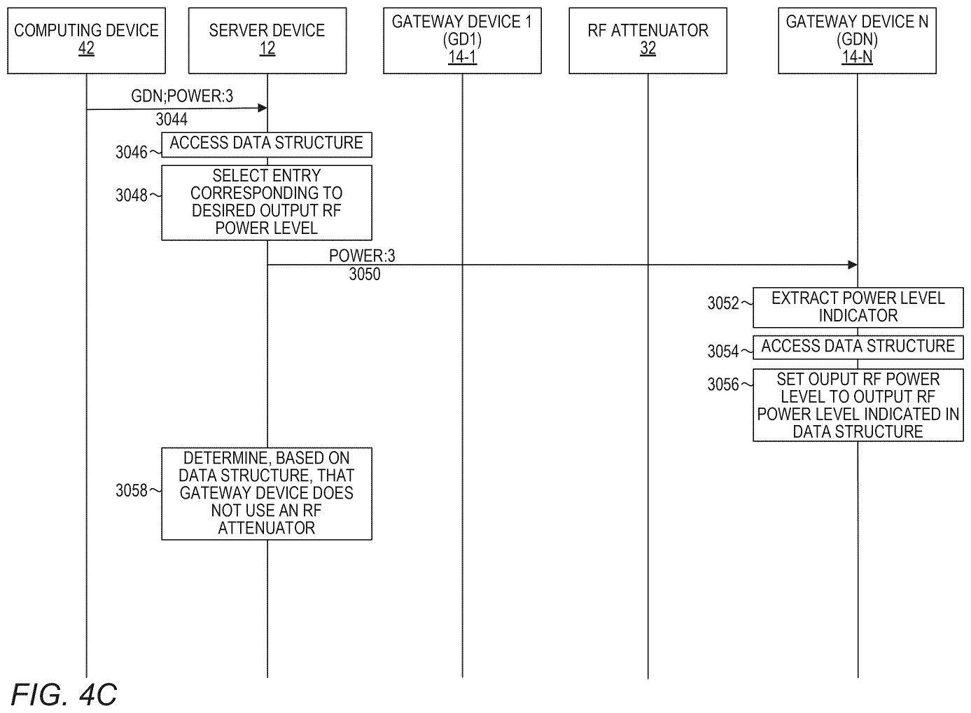

FIGS. 4A-4C are sequence diagrams illustrating actions taken by and messages communicated between various components illustrated in FIG. 1 while implementing power transmission management and interference mitigation on a wireless gateway device according to one example. FIGS. 4A-4C will be discussed in conjunction with FIG. 1. The operator 44 manipulates the UI 46 to cause the computing device 42 to send an instruction to the server device 12 to cause the gateway device 14-1 to transmit at a desired output RF power level, which in this example is 3 dBm (FIG. 4A, step 3000). The server device 12 receives the instruction, and accesses the data structure 52 that corresponds to the gateway device 14-1 (FIG. 4A, step 3002). The server device 12 selects the entry 57 that corresponds to the desired output RF power level (FIG. 4A, step 3004). The server device 12 sends a message that includes the power level indicator identified in the entry 57 to the gateway device 14-1 (FIG. 4A, step 3006). The gateway device 14-1 receives the message and extracts the power level indicator (FIG. 4A, step 3008). The gateway device 14-1 accesses the data structure 28 that correlates a plurality of power level indicators to corresponding output RF power levels of the gateway device 14-1 (FIG. 4A, step 3010). In this example, the data structure correlates the power level indicator to an output RF power level that is different from the desired output RF power level.

The gateway device 14-1 sets the output RF power level of the gateway device 14-1 to the indicated output RF power level, in this example 4 dBm (FIG. 4A, step 3012). The server device 12 determines, based on the column 59 of the data structure 52, that the gateway device 14-1 utilizes an RF attenuator and that the RF attenuator should be instructed to attenuate the output RF power level from the gateway device 14-1 by 1 dBm. The server device 12 accesses the device address data structure 61 and determines that the RF attenuator 32 is the RF attenuator 32 that operates with the gateway device 14-1, and obtains the address of the RF attenuator 32 (FIG. 4A, step 3014). The server device 12 sends an instruction to the RF attenuator 32 via the gateway device 14-1 to attenuate the output RF power level of the gateway device 14-1 by 1 dBm (FIG. 4A, step 3016). The gateway device 14-1 delivers the instruction to the RF attenuator 32 (FIG. 4A, step 3018). The RF attenuator 32 begins to attenuate the output RF power level of the gateway device 14-1 by 1 dBm (FIG. 4A, step 3020).

Referring now to FIG. 4B, the operator 44 subsequently manipulates the UI 46 to cause the computing device 42 to send an instruction to the server device 12 to cause the gateway device 14-1 to transmit at a new desired output RF power level, which in this example is 2 dBm (FIG. 4B, step 3022). The server device 12 receives the instruction, and accesses the data structure 52 that corresponds to the gateway device 14-1 (FIG. 4B, step 3024). The server device 12 selects an entry that corresponds to the desired output RF power level (FIG. 4B, step 3026). The server device 12 sends a message that includes the power level indicator identified in the entry 57 to the gateway device 14-1 (FIG. 4B, step 3028). In this example, the power level indicator is “POWER:2”. The gateway device 14-1 receives the message and extracts the power level indicator (FIG. 4B, step 3030). The gateway device 14-1 accesses the data structure 28 that correlates a plurality of power level indicators to corresponding output RF power levels of the gateway device 14-1 (FIG. 4B, step 3032). In this example, the data structure correlates the power level indicator to an output RF power level that is the same as the desired output RF power level (e.g., 2).

The gateway device 14-1 sets the output RF power level of the gateway device 14-1 to the indicated output RF power level, in this example, 2 dBm (FIG. 4B, step 3034). The server device 12 determines, based on the column 59 of the data structure 52, that the gateway device 14-1 utilizes an RF attenuator and that the RF attenuator should be instructed to not attenuate the output RF power level from the gateway device 14-1. The server device 12 accesses the device address data structure 61 and determines that the RF attenuator 32 is the RF attenuator 32 that operates with the gateway device 14-1, and obtains the address of the RF attenuator 32 (FIG. 4B, step 3036). The server device 12 sends an instruction to the RF attenuator 32 via the gateway device 14-1 to not attenuate the output RF power level of the gateway device 14-1 (FIG. 4B, step 3038). The gateway device 14-1 delivers the instruction to the RF attenuator 32 (FIG. 4B, step 3040). The RF attenuator 32 stops attenuating the output RF power level of the gateway device 14-1 (FIG. 4B, step 3042).

Referring now to FIG. 4C, the operator 44 subsequently manipulates the UI 46 to cause the computing device 42 to send an instruction to the server device 12 to cause the gateway device 14-N to transmit at a desired output RF power level, which in this example is 3 dBm (FIG. 4C, step 3044). The server device 12 receives the instruction, and accesses the data structure 54 that corresponds to the gateway device 14-N (FIG. 4C, step 3046). The server device 12 selects an entry that corresponds to the desired output RF power level (FIG. 4C, step 3048). The server device 12 sends a message that includes the power level indicator identified in the entry to the gateway device 14-N (FIG. 4C, step 3050). In this example, the power level indicator is “POWER:3”. The gateway device 14-N receives the message and extracts the power level indicator (FIG. 4A, step 3052). The gateway device 14-1 accesses the data structure 30 that correlates a plurality of power level indicators to corresponding output RF power levels of the gateway device 14-N (FIG. 4C, step 3054). In this example, the data structure correlates the power level indicator to an output RF power level that is the same as the desired output RF power level (e.g., 3).

The gateway device 14-N sets the output RF power level of the gateway device 14-N to the indicated output RF power level, in this example, 3 dBm (FIG. 4A, step 3056). The server device 12 determines, based on the data structure 54 lacking an RF attenuation column, or via any other suitable means, that the gateway device 14-N does not utilize an RF attenuator, and thus that no instruction need to be sent to an RF attenuator.

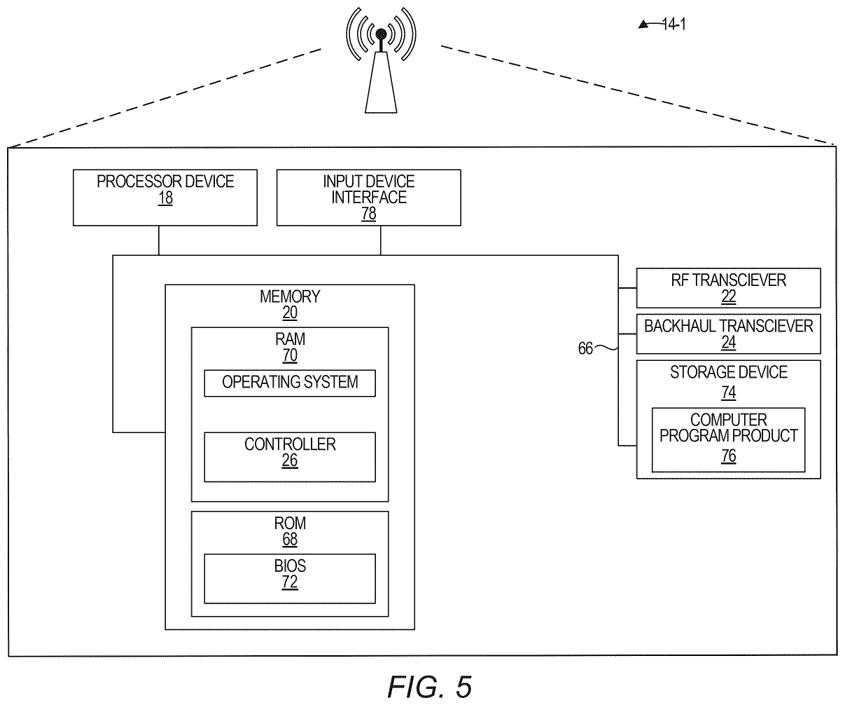

FIG. 5 is a block diagram of the gateway device 14-1 according to one implementation. The gateway device 14-1 may comprise any computing or electronic device capable of including firmware, hardware, and/or executing software instructions to implement the functionality described herein. The gateway device 14-1 includes the processor device 18, the system memory 20, and a system bus 66. The system bus 66 provides an interface for system components including, but not limited to, the system memory 20 and the processor device 18. The processor device 18 can be any commercially available or proprietary processor. The system bus 66 may be any of several types of bus structures that may further interconnect to a memory bus (with or without a memory controller), a peripheral bus, and/or a local bus using any of a variety of commercially available bus architectures. The system memory 20 may include non-volatile memory 68 (e.g., read-only memory (ROM), erasable programmable read-only memory (EPROM), electrically erasable programmable read-only memory (EEPROM), etc.), and volatile memory 70 (e.g., random-access memory (RAM)). A basic input/output system (BIOS) 72 may be stored in the non-volatile memory 68 and can include the basic routines that help to transfer information between elements within the gateway device 14-1. The volatile memory 70 may also include a high-speed RAM, such as static RAM, for caching data.

The gateway device 14-1 may further include or be coupled to a non-transitory computer-readable storage medium such as a storage device 74, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 74 and other drives associated with computer-readable media and computer-usable media may provide non-volatile storage of data, data structures, computer-executable instructions, and the like.

A number of modules can be stored in the storage device 74 and in the volatile memory 70, including an operating system and one or more program modules, such as the controller 26, which may implement the functionality described herein in whole or in part. All or a portion of the examples may be implemented as a computer program product 76 stored on a transitory or non-transitory computer-usable or computer-readable storage medium, such as the storage device 74, which includes complex programming instructions, such as complex computer-readable program code, to cause the processor device 18 to carry out the steps described herein. Thus, the computer-readable program code can comprise software instructions for implementing the functionality of the examples described herein when executed on the processor device 18. The processor device 18, in conjunction with the controller 26 in the volatile memory 70, may serve as a controller, or control system, for the gateway device 14-1 that is to implement the functionality described herein.

An operator may also be able to enter one or more configuration commands through a keyboard (not illustrated), a pointing device such as a mouse (not illustrated), or a touch-sensitive surface such as a display device. Such input devices may be connected to the processor device 18 through an input device interface 78 that is coupled to the system bus 66 but can be connected by other interfaces such as a parallel port, an Institute of Electrical and Electronic Engineers (IEEE) 1394 serial port, a Universal Serial Bus (USB) port, an IR interface, and the like. The gateway device 14-1 also include the RF transceiver 80 for communications with the end devices 16 and the RF attenuator 32, and the backhaul transceiver 24 for communications with the server device 12.

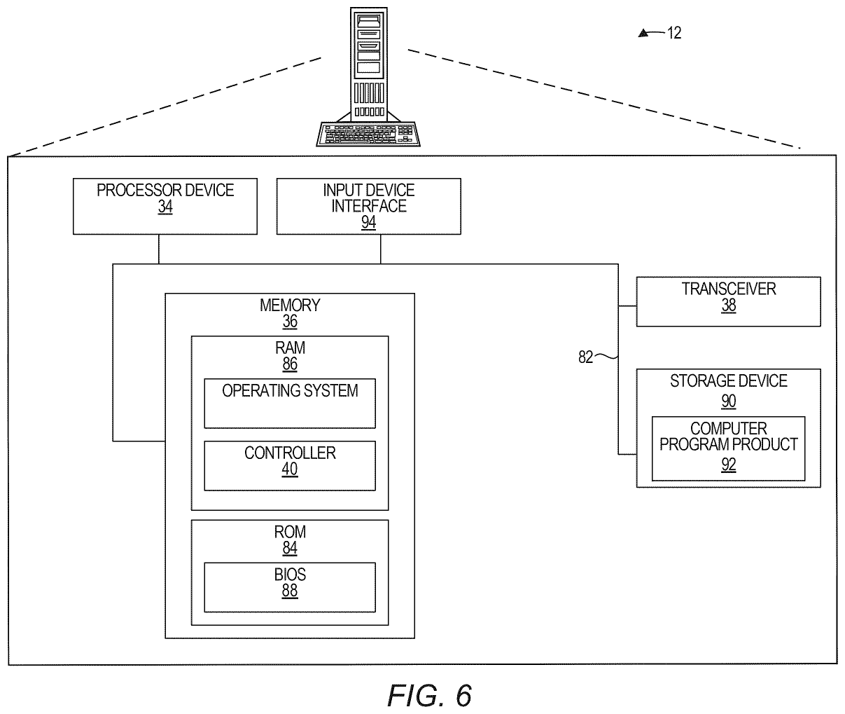

FIG. 6 is a block diagram of the server device 12 according to one implementation. The server device 12 may comprise any computing or electronic device capable of including firmware, hardware, and/or executing software instructions to implement the functionality described herein, such as a computer server or the like. The server device 12 includes the processor device 34, the system memory 36, and a system bus 82. The system bus 82 provides an interface for system components including, but not limited to, the system memory 36 and the processor device 34. The processor device 34 can be any commercially available or proprietary processor.

The system bus 82 may be any of several types of bus structures that may further interconnect to a memory bus (with or without a memory controller), a peripheral bus, and/or a local bus using any of a variety of commercially available bus architectures. The system memory 36 may include non-volatile memory 84 (e.g., read-only memory (ROM), erasable programmable read-only memory (EPROM), electrically erasable programmable read-only memory (EEPROM), etc.), and volatile memory 86 (e.g., random-access memory (RAM)).

A basic input/output system (BIOS) 88 may be stored in the non-volatile memory 84 and can include the basic routines that help to transfer information between elements within the server device 12. The volatile memory 86 may also include a high-speed RAM, such as static RAM, for caching data.

The server device 12 may further include or be coupled to a non-transitory computer-readable storage medium such as a storage device 90, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 90 and other drives associated with computer-readable media and computer-usable media may provide non-volatile storage of data, data structures, computer-execudata structure instructions, and the like.

A number of modules can be stored in the storage device 90 and in the volatile memory 86, including an operating system and one or more program modules, such as the controller 40, which may implement the functionality described herein in whole or in part. All or a portion of the examples may be implemented as a computer program product 92 stored on a transitory or non-transitory computer-usable or computer-readable storage medium, such as the storage device 90, which includes complex programming instructions, such as complex computer-readable program code, to cause the processor device 34 to carry out the steps described herein. Thus, the computer-readable program code can comprise software instructions for implementing the functionality of the examples described herein when executed on the processor device 34. The processor device 34, in conjunction with the controller 40 in the volatile memory 86, may serve as a controller, or control system, for the server device 12 that is to implement the functionality described herein.

An operator may also be able to enter one or more configuration commands through a keyboard (not illustrated), a pointing device such as a mouse (not illustrated), or a touch-sensitive surface such as a display device. Such input devices may be connected to the processor device 34 through an input device interface 94 that is coupled to the system bus 82 but can be connected by other interfaces such as a parallel port, an Institute of Electrical and Electronic Engineers (IEEE) 1394 serial port, a Universal Serial Bus (USB) port, an IR interface, and the like. The server device 12 may also include the transceiver 38 suitable for communicating with the gateway devices 14.

Individuals will recognize improvements and modifications to the preferred examples of the disclosure. All such improvements and modifications are considered within the scope of the concepts disclosed herein and the claims that follow.

What is claimed is:

1. A method, comprising:
receiving, by a gateway device from a server device, a first message, the first message comprising a first power level indicator corresponding to a first desired output radio frequency (RF) power level for the gateway device, the gateway device being inoperable to transmit at the first desired output RF power level;
in response to the first message, setting, by the gateway device, an output RF power level of the gateway device to an output RF power level that is different from the first desired output RF power level; and
sending, by the gateway device to an RF attenuator that is communicatively coupled to an RF output of the gateway device, an instruction to attenuate the output RF power level of the gateway device such that an attenuated output RF power level matches the first desired output RF power level.

2. The method of claim 1, further comprising:
extracting, by the gateway device, the first power level indicator from the first message; and
accessing, by the gateway device, a data structure that correlates a plurality of power level indicators to corresponding output RF power levels of the gateway device, wherein the data structure correlates the first power level indicator to the output RF power level that is different from the desired output RF power level.

3. The method of claim 2, further comprising:
determining, by the gateway device based on the data structure, the instruction to attenuate the output RF power level of the gateway device.

4. The method of claim 1, wherein the instruction to attenuate the output RF power level of the gateway device comprises an instruction to attenuate the output RF power level of the gateway device by 1 decibel.

5. The method of claim 1, further comprising:
receiving, by the gateway device from the server device, the instruction to attenuate the output RF power level of the gateway device such that the attenuated output RF power level matches the first desired output RF power level, the instruction being addressed to the RF attenuator; and
sending, by the gateway device to the RF attenuator, the instruction via a radio frequency signal in a frequency range of 902-928 MHz.

6. The method of claim 1, wherein the gateway device is communicatively coupled to a plurality of end devices, and wherein the gateway device utilizes a low power protocol for wide area wireless networks compliant with International Telecommunication Union recommendation ITU-T Y.4480 to communicate with the plurality of end devices.

7. The method of claim 1, wherein the gateway device communicates with the RF attenuator via a low power protocol for wide area wireless networks compliant with International Telecommunication Union recommendation ITU-T Y.4480.

8. The method of claim 1, further comprising:
receiving, by the gateway device from the server device, a second message, the second message comprising a second power level indicator corresponding to a second desired output RF power level for the gateway device, the gateway device being operable to transmit at the second desired output RF power level;
in response to the second message, setting, by the gateway device, the output RF power level of the gateway device to the second desired output RF power level; and
sending, by the gateway device to the RF attenuator, an instruction to not attenuate the output RF power level of the gateway device.

9. A gateway device, comprising:
a memory; and
a processor device coupled to the memory, the processor device operable to:
receive, from a server device, a first message, the first message comprising a first power level indicator corresponding to a first desired output radio frequency (RF) power level for the gateway device, the gateway device being inoperable to transmit at the first desired output RF power level;
in response to the first message, set an output RF power level of the gateway device to an output RF power level that is different from the first desired output RF power level; and
send, to an RF attenuator that is communicatively coupled to an RF output of the gateway device, an instruction to attenuate the output RF power level of the gateway device such that an attenuated output RF power level matches the first desired output RF power level.

10. The gateway device of claim 9, wherein the processor device is further operable to:
extract the first power level indicator from the first message;
access a data structure that correlates a plurality of power level indicators to corresponding output power levels of the gateway device, wherein the data structure correlates the first power level indicator to the output RF power level that is different from the desired output RF power level.

11. The gateway device of claim 10, wherein the processor device is further operable to:
determine, based on the data structure, the instruction to attenuate the output RF power level of the gateway device.

12. The gateway device of claim 9, wherein the instruction to attenuate the output RF power level of the gateway device comprises an instruction to attenuate the output RF power level of the gateway device by 1 decibel.

13. The gateway device of claim 9, wherein the processor device is further operable to:
receive, from the server device, the instruction to attenuate the output RF power level of the gateway device such that the attenuated output RF power level matches the first desired output RF power level, the instruction being addressed to the RF attenuator; and
send, to the RF attenuator, the instruction via a radio frequency in a frequency range of 902-928 MHz.

14. The gateway device of claim 9, further comprising:
a transceiver operable to implement a low power protocol for wide area wireless networks compliant with International Telecommunication Union recommendation ITU-T Y.4480 to communicate with a plurality of end devices.

15. The gateway device of claim 9, wherein the gateway device communicates with the RF attenuator via a low power protocol for wide area wireless networks compliant with International Telecommunication Union recommendation ITU-T Y.4480.

16. A method, comprising:
receiving, by a server device, an instruction to cause a first gateway device to transmit at a first desired output radio frequency (RF) power level;
accessing, by the server device, a first data structure that corresponds to the first gateway device, the first data structure correlating a first plurality of power level indicators to corresponding output RF power levels;
sending, by the server device to the first gateway device based on the first data structure, a first power level indicator that corresponds to the first desired output RF power level; and
sending, by the server device to an RF attenuator that is communicatively coupled to the first gateway device, an instruction to attenuate the output RF power level of the first gateway device to cause an attenuated output RF power level to match the first desired output RF power level.

17. The method of claim 16, further comprising:
receiving, by the server device, an instruction to cause a second gateway device to transmit at a second desired output RF power level;
accessing, by the server device, a second data structure that corresponds to the second gateway device, the second data structure correlating a second plurality of power level indicators to corresponding output RF power levels;
determining, by the server device based on the second data structure, that the second gateway device is operable to transmit at the second desired output RF power level;
sending, by the server device to the second gateway device based on the second data structure, a second power level indicator that corresponds to the second desired output RF power level; and
in response to determining that the second gateway device is operable to transmit at the second desired output RF power level, sending, by the server device to an RF attenuator that is communicatively coupled to the second gateway device, an instruction to not attenuate an output RF power level of the second gateway device.
